(19) United States
(12) Patent Application Publication
(10) Pub. No.: US 2020/0312203 A1
(43) Pub. Date: Oct. 1, 2020

(54) PUMP AND ADVERTISING MAT

(71) Applicants: Randy Taylor, Bonaire, GA (US); Bobby P. Taylor, Perry, GA (US)

(72) Inventors: Randy Taylor, Bonaire, GA (US); Bobby P. Taylor, Perry, GA (US)

(21) Appl. No.: 16/420,149

(22) Filed: May 22, 2019

Related U.S. Application Data
(63) Continuation-in-part of application No. 14/096,000, filed on Dec. 3, 2013.

(51) Int. Cl. G09F 19/22; G09F 7/00

(52) U.S. Cl. CPC G09F 19/228; G09F 7/00

(57) ABSTRACT

Implementations of the advertising mat of the present disclosure include a plurality of advertisements from businesses. In some implementations, an advertising mat of the present disclosure may include advertisements from local businesses (e.g., within a certain mile radius of the advertising mat). In some implementations, an advertising mat of the present disclosure may include advertisements from any business including local, non-local, wholesale, retail, or any other business. In some implementations, an advertising mat of the present disclosure may include one or more advertisements having respective matrix barcodes (or two-dimensional codes) such as QR (Quick Response) codes. In some implementations, the one or more advertisements may include respective coupons.

### CROSS REFERENCE TO RELATED APPLICATION

This continuation in part application claims the benefit of U.S. patent application Ser. No. 14/096,000, filed on Dec. 3, 2013, which claims the benefit of U.S. Patent Application Ser. No. 61/732,497, which was filed on Dec. 3, 2012. All of the aforementioned applications are incorporated herein by reference in their entirety.

### TECHNICAL FIELD

This disclosure relates to an pump and advertising mat in combination or singularly.

### BACKGROUND

Existing advertising mats may be located at a retail store and advertise either the retail store or advertise products that may be purchased at the retail store. Static free mats are typically used in industrial areas. There does not exist a static free advertising mat at a business location that advertises a plurality of other businesses.

### BRIEF DESCRIPTION OF THE DRAWINGS

FIGS. 1 and 2 illustrate example implementations of an advertising mat of the present disclosure.

### DETAILED DESCRIPTION

Implementations of the advertising mat of the present disclosure include a plurality of advertisements from businesses. In some implementations, an advertising mat of the present disclosure may include advertisements from local businesses (e.g., within a certain mile radius of the advertising mat). In some implementations, an advertising mat of the present disclosure may include advertisements from any business including local, non-local, wholesale, retail, or any other business. In some implementations, an advertising mat of the present disclosure may include one or more advertisements having respective matrix barcodes (or two-dimensional codes) such as QR (Quick Response) codes. In some implementations, the one or more advertisements may include respective coupons.

In some implementations, a method of advertising comprises printing a plurality of advertisements on an advertising mat wherein the advertisements are from different businesses that are off the premise of the gas pump and placing the advertisement mat on the ground at the base of a gas pump. In some implementations, the method of advertising comprises the determining existing businesses located within a predetermined distance of the advertising mat, selecting retail businesses from the existing businesses, and printing on the advertising mat advertisements for a predetermined number of the selected retail businesses.

In some implementations, off the premise, as stated in the description herein, will be understood by one of ordinary skill in the art to be at a different address, a different tract of land, a different business, or another separate different location.

In some implementations, an advertising mat of the present disclosure may be placed at the base of a gas pump. In this way, a person standing at the base of the gas pump may view the advertisements on the mat while pumping gas. In some implementations, the present disclosure include a station a gas pump; and an advertisement mat comprising pre-printed advertisements located on the ground at the base of the gas pump wherein the advertisements are from different businesses that are off the premise of the gas pump.

In some implementations, a prospective customer may redeem a coupon or discount advertised on an advertising mat of the present disclosure by capturing (i.e., scanning or taking a picture of) the coupon, or of a matrix barcode associated with the coupon, with a camera, mobile telephone, tablet, smart device, or any other handheld device and display the electronic coupon (i.e., photo of the coupon) at the corresponding retailer. In some implementations, the prospective customer may forward the picture to another prospective customer and that person may also redeem the coupon as described above. In some implementations, a discount may be applied at a retailer based on a coupon associated with the matrix barcode.

In some implementations, a prospective customer may use a two-dimensional code on the advertising mat to retrieve a coupon on the Internet.

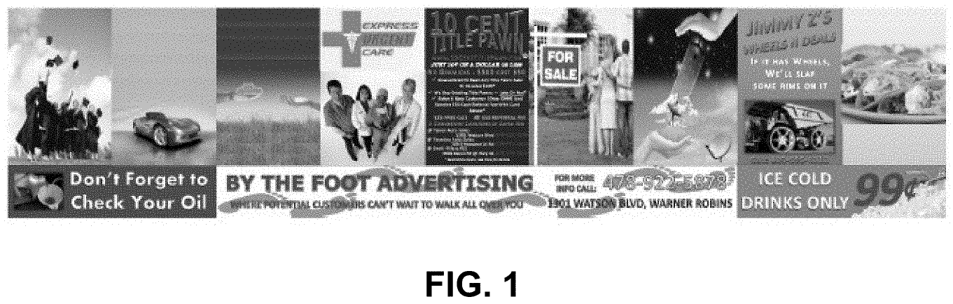

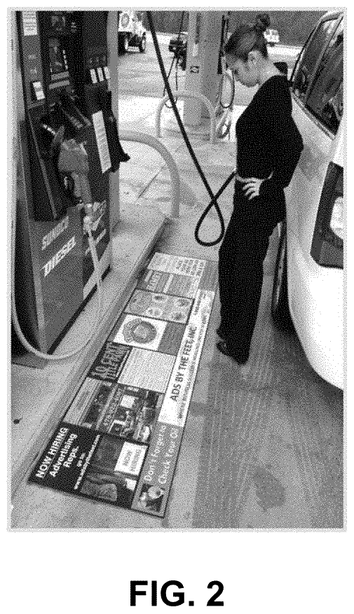

FIG. 1 illustrates an example implementation of an advertising mat of the present disclosure. In some implementations, the advertising mat may be 9 ft. long and 2 ft. wide (9′×2′). In some implementations, the advertising mat is any other dimension. In some implementations, the advertising mat may include a plurality of equally-sized rectangular (e.g. 12″×18″) advertisements and a banner advertisement extending the length of the advertising mat as shown in FIG. 1. The advertisements on the advertising mat can be the same dimension or different dimensions. The advertising mat can include any number of advertisements.

In some implementations, the advertising mat may include a metal backing.

In some implementations, the advertising mat may be comprised of multiple layers. In some implementations, the bottom layer may be a thin sheet of plastic, the middle layer may be comprised of a vinyl sheet, and the top layer may be a thin sheet of plastic which may have non-skid properties. In some implementations, the top and bottom layers may be laminated to the vinyl sheet which comprises the middle layer. In some implementations, the vinyl layer may be manufactured from a thin banner material suitable for printing an advertisement thereon.

In some implementations, the advertising mat can be secured to concrete, asphalt or other similar surfaces through the use of a water based adhesive. The adhesive can be applied to the backside of the bottom layer, which may be comprised of a thin sheet of plastic, which is then pressed onto a concrete, asphalt, or other, similar surface. In some implementations, the any suitable adhesive may be used to secure the thin sheet of plastic to a concrete, asphalt, or other, similar surface.

In another implementation, the advertising mat is comprised of a bottom layer that may be a piece of plastic or metal, a middle layer that may be comprised of vinyl, and a top layer that may be a polyurethane coating. In some implementations, the polyurethane coating may have non-skid properties. In some implementations, the polyurethane of the top layer is sprayed, rolled, or brushed onto the top side of the middle layer of vinyl. In some implementations, the polyurethane is applied to the top layer of vinyl by any suitable method. In some implementations, the middle layer is affixed to the bottom layer of plastic or metal through any suitable means such as lamination, or through the use of a suitable adhesive. In some implementations, the vinyl layer may be a thin banner material suitable for printing an advertisement thereon. In some implementations, the vinyl may be a thick banner material suitable for printing an advertisement thereon.

In some implementations, the middle layer may be manufactured from a material suitable for printing an advertisement thereon. In some implementations, the middle layer may be flexible. In some implementations, the middle layer may be comprised of a sticker having a printed advertisement on one side and an adhesive on the other. Constructing the middle layer as a sticker allows it, and thereby a top layer, to be peeled off of the bottom layer and replaced.

In some implementations, the advertising mat can be secured to concrete, asphalt or other similar surfaces through the use of an adhesive. The adhesive can be applied to the backside of the bottom layer, which may be comprised of a piece of plastic or metal, then pressed onto a concrete, asphalt, or other, similar surface.

In some implementations, the plastic or metal layer is intended to be secured to concrete, asphalt, or other similar surface for an extended period of time and the middle and top portion are intended to be replaced during a shorter period of time.

In another implementation, the advertising mat may take the form of a standard door mat. In some implementations, the door mat may be manufactured from a plastic such as polyvinyl chloride (PVC) or vinyl. In some implementations, the door mat may be manufactured from rubber or other suitable materials. In some implementations, an advertisement may be printed directly onto the top surface of the mat. In some implementation, a sticker having a printed advertisement on one side and an adhesive on the other can be placed on top of at least a portion of the door mat.

In some implementations, the door mat can be manufactured from a thick piece of material. In some implementations, the door mat can be manufactured from a thin piece of material.

In some implementations, the door mat can be secured to a concrete, asphalt or other similar surface through the use of an adhesive. The adhesive can be applied to the backside of the door mat which is then pressed onto a concrete, asphalt, or other, similar surface. In some implementations, a water based adhesive may be used. In some implementations, any suitable industrial adhesive may be used. In some implementations, any suitable adhesive may be used.

The adhesive used with some implementations of the advertising mat described herein may serve as a moisture barrier between the advertising mat, or door mat, and the concrete, asphalt, or other similar surface to which it is secured.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A method comprising:
printing a plurality of advertisements on an advertising mat, wherein the advertisements are from different businesses that are off the premise of a gas pump, and at least one of the advertisements includes a matrix barcode;
creating the advertising mat by forming a bottom layer comprised of metal, forming a middle layer comprised of a vinyl sheet and printing the advertisements thereon, and forming a top layer comprised of polyurethane;
determining existing businesses off the premise of the gas pump that are located within a predetermined distance of the advertising mat;
selecting retail businesses from the existing businesses off the premise of the gas pump;
printing on the advertising mat the advertisements from a predetermined number of the selected retail businesses;
placing the advertisement mat on the ground at the base of the gas pump;
displaying the advertisements from the selected retail businesses, wherein the advertisements are of products or services that are provided off the premise of the gas pump;
capturing the matrix barcode of the at least one of the advertisements with a handheld device, wherein capturing the matrix barcode comprises scanning or taking a photo of the matrix barcode;
retrieving a coupon based on the captured matrix barcode of the at least one of the advertisements; and
applying a discount off the premise of the gas pump at one of the selected retail businesses based on the coupon retrieved based on the matrix barcode.

2. The method of claim 1, wherein the bottom layer is alternatively formed of plastic and the top layer is alternatively formed of plastic.

3. The method of claim 1, further comprising forming the middle layer as a sticker by printing the advertisements on one side and placing an adhesive on the other side.

4. The method of claim 1, further comprising creating the advertising mat by forming a single layer of synthetic material and printing the advertisements thereon.

5. The method of claim 1, further comprising forming the top layer for the advertising mat as a sticker by printing the advertisements on one side and placing an adhesive on the other side.

6. The method of claim 1, further comprising applying the discount off the premise of the gas pump at one of the selected retail businesses based on a photo taken of the coupon, wherein the coupon is included in one of the advertisements displayed on the advertising mat.

7. A station comprising:
a gas pump; and
an advertisement mat comprising pre-printed advertisements located on the ground at the base of the gas pump, wherein:
the advertisement mat comprises a bottom layer comprised of metal and a middle layer comprised of a vinyl sheet having the pre-printed advertisements thereon;
the advertisements are from different businesses that are off the premise of the gas pump; and
the advertisements are of products or services from the businesses that are provided off the premise of the gas pump.
